(19) United States
(12) Patent Application Publication
(10) Pub. No.: US 2011/0218331 A1
(43) Pub. Date: Sep. 8, 2011

(54) Method of Preparation of DTPA Crosslinked Hyaluronic Acid Derivatives and Modification of Said Dervivatives

(75) Inventors: Radovan Buffa, Humenne (SK); Vladimir Velebny, Zamberk (CZ); Lukas Palek, Plzen (CZ); Sofiane Kettou, Uherske Hradiste (CZ); Martin Pravda, Chrudim (CZ)

(73) Assignee: CPN S.R.O., (CZ)

(21) Appl. No.: 13/127,871

(22) PCT Filed: Nov. 5, 2009
(86) PCT No.: PCT/CZ2009/000131

§ 371 Date: May 5, 2011

(30) Foreign Application Priority Data
Nov. 6, 2008 (CZ) PV2008705

(51) Int. Cl. C08B 37/00

(52) U.S. Cl. 536/18.7

(57) ABSTRACT

The invention relates to the modification of hyaluronic acid by means of a protonized DTPA bis anhydride in a non-basic polar aprotic solvent in absence of any external base to form crosslinked products. The reaction runs via the formation of a complex and the acylating agent is the hyaluronan co-cation itself, i.e. protonized DTPA bis anhydride. The final crosslinked derivative (linker) comprises three carboxylic groups and three tertiary amines which are capable of complexing various metals effectively. The final DTPA crosslinked hyaluronic acid may also be hydrophobized by means of mono, bis or tris functional alkylating agents.

### TECHNICAL FIELD

This invention relates to a new method of modification of hyaluronic acid, forming crosslinked derivatives of DTPA (diethylene triamine pentaacetic acid), and to reactions of so modified derivatives. The modification of hyaluronic acid is performed by means of a protonized DTPA bis anhydride in a non-basic polar aprotic solvent in absence of any external base to form crosslinked products. Linkers of said crosslinked derivatives comprise three carboxylic groups and three tertiary amines which are capable of complexing various metals effectively and also enable further modification of DTPA carboxylic group, e.g. hydrophobization of the crosslinked derivative by alkylating agents.

### BACKGROUND ART

Polysaccharides are polymers composed of simple monosaccharides (monomer units) linked by the glycosidic bond. They are classified based on the number of the repeating units to oligosaccharides (2 to 10 units) and polysaccharides (10 or more units). The importance of polysaccharides is very high. Polysaccharides have a nutritional, protective, building (cellulose, chitin) or storing (starch) function. Polymers are, generally characterised by an average molecular weight which typically falls within the range between 16.10³ g·mol⁻¹ to 16.10³ g·mol⁻¹. The number of the repeating units depends on the degree of polymerisation.

An important polysaccharide is hyaluronic acid

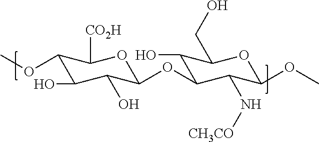

composed of repeating units β-(1,3)-D-glucuronic acid and β-1,4)—N-acetyl-D-glucosamine. it is characterised by a high molecular weight of 5.10⁴ to 5.10⁶ g·mol⁻¹ which depends on isolation method and on the initial material. Hyaluronic acid, or its salt hyaluronan, is an essential part of the connective tissue, synovial joint fluid, and plays an important role in a number of biological processes such as hydration, proteoglycan organisation, cell differentiation, proliferation and angiogenesis. This highly hydrophilic polysaccharide is water-soluble in the form of a salt within the whole pH range.

Hyaluronic acid is a representative, of the glycosaminoglycans group which further includes chondroitin sulphate, dermatan sulphate, keratan sulphate and heparan sulphate.

### Acylation of the Hyaluronic Acid

Acylation of hyaluronic acid is the most frequently used method for introducing an alkyl chain which modifies the characteristics of mostly hydrophilic compounds to hydrophobic compounds. Most frequently, the reaction is performed by means of a reaction with anhydrides of the respective acids, chlorides of the acids or the acid itself with an addition of catalysts.

The preparation of acyl-derivatives of hyaluronic acid oligomers is patented by Couchmann et al. (U.S. Pat. No. 4,761,401; 1988) where the acylation takes place both on the hydroxyl group and on the amino group of the deacetylated hyaluronan. O-acylation includes the reaction with an organic acid with an addition of an acid catalyst (mineral acid, organic acid or Lewis acid) and an activating agent (N,N′-dicyclo hexyl carbodiimide, 2-chloro-1-methylpyridinium iodide and N,N′-carbonyl diimidazol), or uses acid anhydrides or chlorides in the presence of a base. Michinori et al. (JP 7309902; 1995) prepared an acylated hyaluronic acid by means of the reaction with carboxylic acid anhydrides or carboxylic acid acylhalogenides in an aqueous medium comprising a water-miscible organic solvent in the presence of a catalyst. The saponification of acyl groups of the hyaluronic acid gave rise to derivatives having any number of acyl groups. Also Perbellini et al. (WO 2004/056877 A1; 2004) used the retinoic acid chloride and butyric acid anhydride for the preparation of specific derivatives of hyaluronic acid. The hyaluronic acid in the form of tetrabutyl ammonium salts was used for the synthesis in N,N′-dimethyl formamide medium.

### Crosslinking of the Hyaluronic Acid

Crosslinking of the hyaluronic acid was described in several methods. The most simple method is crosslinking by means of POCl₃ (U.S. Pat. No. 5,783,691). Balasz et al. crosslinked the hyaluronic acid by means of divinyl sulfone (U.S. Pat. No. 4,582,865). Other reactive electrophiles which are suitable for crosslinking include aldehydes (U.S. Pat. No. 4,713,448). Further agents which are frequently used and which are able to react with two polymers are epoxides and bis epoxides (WO 86/00912, WO 2007/129828), wherein the best known representative of these is epichlorohydrin.

The use of EDC enhances the reactivity of the carboxylic group of hyaluronic acid which is then capable of crosslinking reactions with polyanionic compounds (U.S. Pat. No. 4,937,270).

Polyhydrazides represent other nucleophilic reactants (WO 2006/001046). The method of hyaluronic acid crosslinking by means of a polyanhydride, poly(alkyloyl chloride), polyepoxide, and poly carbodiimide was disclosed in WO 00/46252. The reaction of bis carbodiimide with hyaluronic acid (WO 2005/067994) results in crosslinking by means of a reactive electrophilic agent. Crosslinking via redox reactions is disclosed in EP 1683812 A1, where disulphide bridges between thiol derivatives and hyaluronic acid are formed. Another specific crosslinking method is a photochemical reaction. It is well known that the vinylene group of cinnamic acid or an aryl-substituted analogue thereof is capable of photochemical cyclization to cyclobutane. This fact was used by the authors of EP 1217008 A1 who acylated the N-deacylated derivative of hyaluronic acid on the nitrogen of the glucosamine moiety of the polysaccharide with cinnamic acid chloride. The crosslinking itself was effected by radiation by the light having the wave length of 280 nm. Besides the cinnamic acid, it is possible to use other photo-reactive groups linked to the hyaluronic acid (WO 97/18224, EP 0763754 A2) which give rise to crosslinked derivatives due to the radiation by the light having an appropriate wave length. The patents aimed at hyaluronic acid acylation and crosslinking in the presence of a base or in a basic solvent were published by Yui et al. (U.S. Pat. No. 6,673,919) and Nguyen et al. (U.S. Pat. No. 5,690,961).

The drawbacks of the above mentioned known methods include the difficult purification of the crosslinked hyaluronic acid derivatives of the toxic low-molecular polar compounds which are trapped in the derivatives net, the complicacy of the known methods, and so on. Compared to the known methods, the method according to the invention is simpler and does not require the presence of extremely toxic solvents or acylation catalysts.

### DISCLOSURE OF THE INVENTION

The subject-matter of the invention is a method of the preparation hyaluronic acid derivatives by means of a reaction of the hyaluronic acid with a protonized DTPA bis anhydride (diethylene triamine pentaacetic acid bis anhydride) according to the Scheme 1:

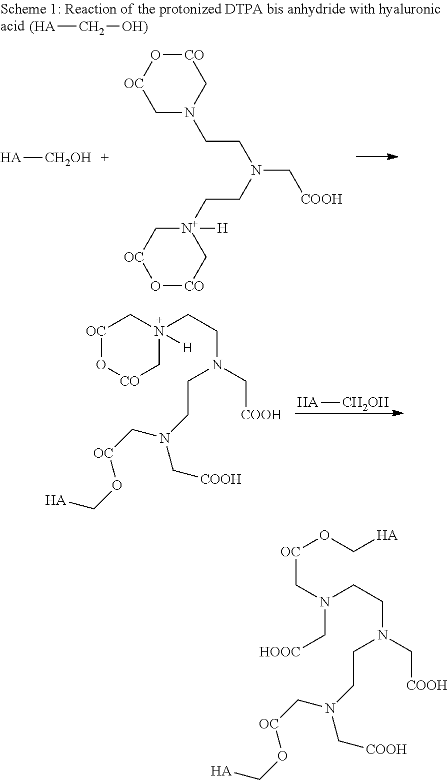

The reaction takes place in a non-basic polar aprotic solvent in absence of an external base, resulting in forming crosslinked products. The solvent is preferably selected from the group comprising DMSO, sulpholan, or dialkysulphones. The hyaluronic acid is preferably in the form of a free acid or a salt and, preferably, has the molecular weight within the range from 1.10⁴ to 5.10⁶ g·mol⁻¹ and the polydispersity index within the range from 1.02 to 5.0.

The suggested method is, compared to the known methods, simpler and does not require the presence of highly toxic solvents or acylation catalysts.

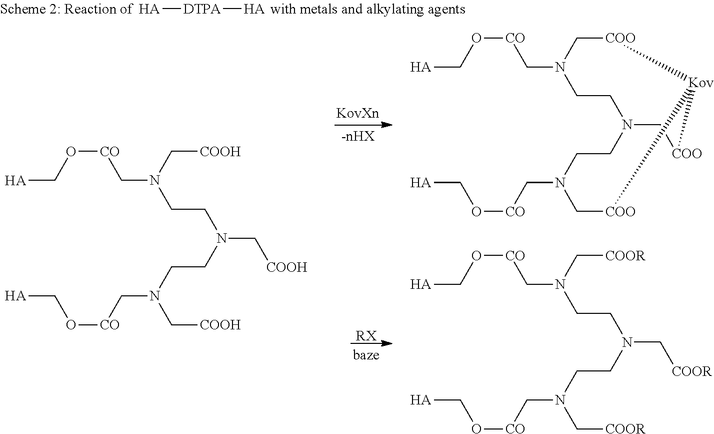

Bonding of DTPA bis anhydride to HA by an esteric bond takes place at 15 to 70° C., preferably at 60° C., which can be explained by the fact that DTPA bis anhydride is protonized by the carboxylic group of hyaluronic acid resulting in the formation of a complex, wherein the acylation agent is the hyaluronan co-cation itself. The respective acylation takes place either directly on one of the hydroxy groups, or on the carboxylate group of the glucuronic moiety and subsequently in an intramolecular way on the hydroxy group—see Scheme 3.

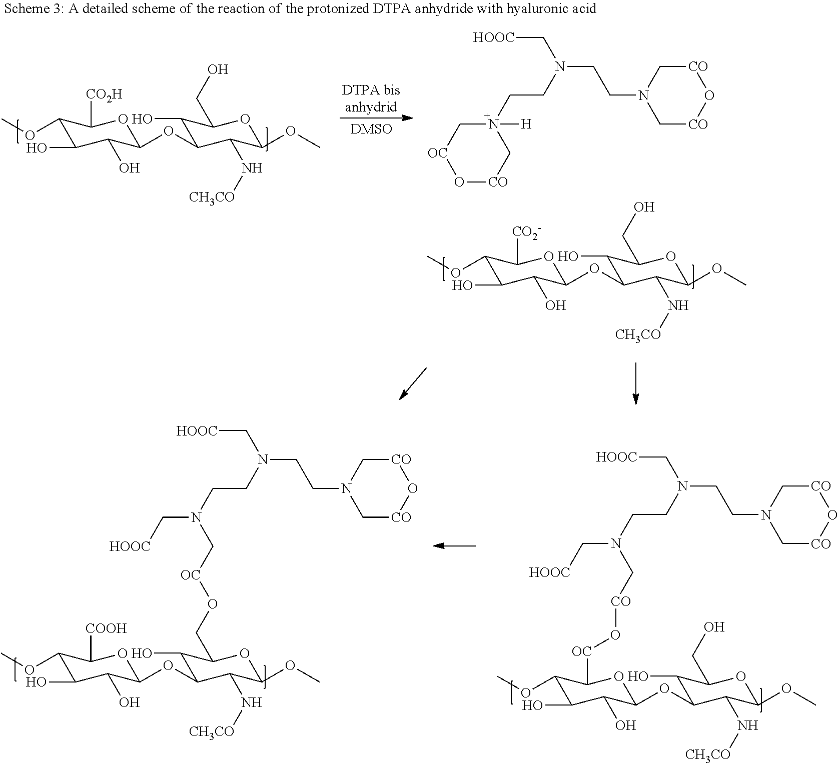

¹H NMR spectrum of the mixture of hyaluronic acid and DTPA bis anhydride in the deuterated DMSO in the time 0.1 hour to 24 hours (see FIG. 1) confirms the extinction of the original hydrogen signals of —N—CH₂—CH₂—N— belonging to DTPA bis anhydride (3.3; 3.4; 3.65; 3.85 ppm) and the presence of a new quality (peaks) within the range from 3.2 to 3.8 ppm indicating the formation of a protonized DTPA bis anhydride. The table data of pKa values of analogue systems (R—COOH—pKa˜4, alkyl₃N—pKa˜11) prefer this possibility as well.

The method according to the invention comprises dissolving the hyaluronic acid preferably in DMSO or sulpholan, adding DTPA bis anhydride and mixing the mixture in absence of air humidity at 15 to 70° C., preferably at 60° C., for 1 to 150 hours, preferably for 24 hours.

The linker, i.e. the crosslinked derivative, contains three carboxylic groups and three terciary amines which are capable of effective complexing various metals and offer the possibility to hydrophobize the carboxylic groups of DTPA linker by means of mono, bis and tris-functional alkylating agents—see Scheme 2.

Complexes of crosslinked derivatives of hyaluronic acid and diethylene triamine pentaacetic acid with metal atoms are prepared by the reaction of a chloride or acetate of the respective metal, such as alkaline earth metals—Ca, Mg, or transition metals—Fe, Gd, In, Zn, Eu, Tb, in water or in a polar aprotic solvent at 15 to 70° C., preferably at 20° C., for 1 minute to 24 hours. With regard to the complexing characteristics of DTPA it is possible to form chelate complexes of DTPA hyaluronan e.g. with gadolinium for diagnostic purposes or with indium ¹¹³In for the purposes of monitoring the distribution of hyaluronan in a living organism or with zinc which could, in the complex with DTPA hyaluronan, show a certain activity applicable in cosmetics.

The hydrophobization of crosslinked derivatives of hyaluronic acid and DTPA occurs upon the reaction with mono, bis or tris-alkylating agents in water or in polar aprotic solvent or in a mixture thereof with a base at the temperature between 15 to 70° C., preferably at 60° C., for 1 to 150 hours. Alkylating agents of the general formula R—X include alkyl(aryl)halogenides wherein R is C₁-C₃₀ having a linear or a branched chain, optionally containing aromatic or heteroaromatic groups, and X is halogen, or alkyl(aryl)sulphates, wherein R has the above indicated meaning and X is the group —O—SO₂—R. The used bases include inorganic compounds having the general formula MHCO₃, M₂CO₃, MF, wherein M is an alkali metal, or nitrogen organic bases having the general formula R₃N, wherein R is C₁-C₃₀ having a linear or a branched chain, optionally containing aromatic or heteroaromatic groups.

The molecular weights of the hyaluronic acid and the derivatives thereof are weight average molecular weights.

### BRIEF DESCRIPTION OF THE DRAWINGS

FIG. 1 represents the changes in ¹H NMR spectrum of the mixture of hyaluronic acid and DTPA bis anhydride in DMSO in the time 0.1 hour to 24 hours.

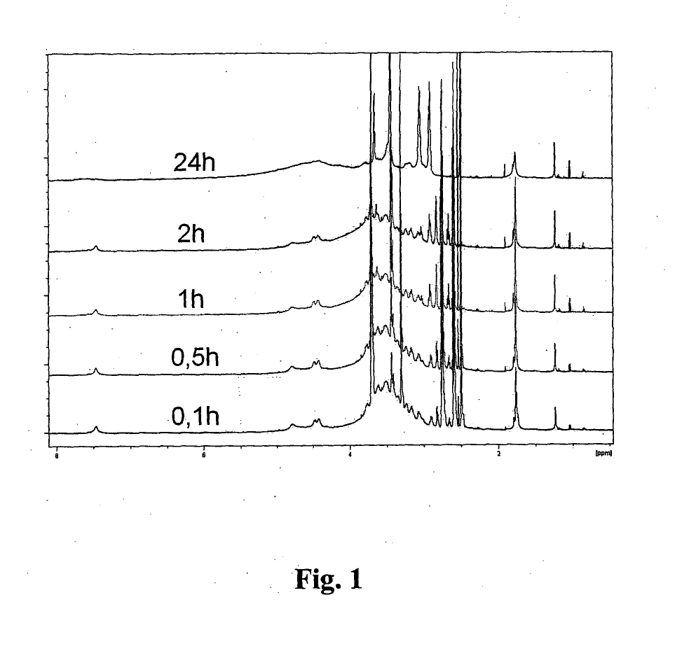

### MODES FOR CARRYING OUT THE INVENTION

### Example 1

### Modification of the Hyaluronic Acid with DTPA Bis Anhydride

The acid form of the hyaluronic acid HA-COOH (10 kDa, 50 mg) was dissolved in an anhydrous DMSO (5 ml) at 60° C. DTPA bis anhydride (95 mg) was added to the polysaccharide solution at 60° C. and the mixture was stirred for 24 hours in absence of air humidity. After cooling of the mixture by ice water, distilled water and a solution of 150 mg of Na₂CO₃ in 30 mL of water were added, the mixture was stirred for 30 minutes and then was diluted by distilled water to 100 mL and dialysed against distilled water 7 times with 1 L. The final solution was lyophilized to yield 88 mg of the product.

M_{w}=2800 kDa, Polydispersity index=2.563 (measured by SEC-MALL method),

IR 1739 cm⁻¹, substitution degree 0.110% (calculated from NMR with respect to a polysaccharide dimer), ¹H NMR (calculated after the addition of 0.02 mL of 20% aq NaOD) DTPA (δ 2.55 4H, 2.6 4H, 3.10 2H, 3.5 6H), ¹³C NMR DTPA (δ 183.0, 182.8, 61.5, 61.1, 54.5, 54.4 ppm).

### Example 2

### Modification of the Hyaluronic Acid with DTPA Bis Anhydride

The acid form of the hyaluronic acid HA-COOH (10 kDa, 50 mg) was dissolved in an anhydrous sulpholan (5 ml) at 60° C. DTPA bis anhydride (95 mg) was added to the polysaccharide solution at 60° C. and the mixture was stirred for 24 hours in absence of air humidity. After cooling of the mixture by ice water, distilled water and a solution of 150 mg of Na₂CO₃ in 30 mL of water were added, the mixture was stirred for 30 minutes and then was diluted by distilled water to 100 mL and dialysed against distilled water 7 times with 1 L. The final solution was lyophilized to yield 78 mg of the product.

M_{w}=2600 kDa, Polydispersity index=2.951 (measured by SEC-MALL method),

IR 1739 cm⁻¹, substitution degree 98% (calculated from NMR with respect to a polysaccharide dimer), ¹H NMR (calculated after the addition of 0.02 mL of 20% aq NaOD) DTPA (δ 2.55 4H, 2.6 4H, 3.10 2H, 3.5 6H), ¹³C NMR DTPA (δ 183.0, 182.8, 61.5, 61.1, 54.5, 54.4 ppm).

### Example 3

### Modification of the Hyaluronic Acid with DTPA Bis Anhydride

The acid form of the hyaluronic acid HA-COOH (350 kDa, 50 mg) was dissolved in an anhydrous DMSO (5 ml) at 60° C. DTPA bis anhydride (95 mg) was added to the polysaccharide solution at 60° C. and the mixture was stirred for 24 hours in absence of air humidity. After cooling of the mixture by ice water, distilled water and a solution of 150 mg of Na₂CO₃ in 30 mL of water were added, the mixture was stirred for 30 minutes and then was diluted by distilled water to 100 mL and dialysed against distilled water 7 times with 1 L. The final solution was lyophilized to yield 83 mg of the product.

M_{w}=2600 kDa, Polydispersity index=2.951 (measured by SEC-MALL method),

IR 1739 cm⁻¹, substitution degree 90% (calculated from NMR with respect to a polysaccharide dimer), ¹H NMR (calculated after the addition of 0.02 mL of 20% aq NaOD) DTPA (δ 2.55 4H, 2.6 4H, 3.10 2H, 3.5 6H), ¹³C NMR DTPA (δ 183.0, 182.8, 61.5, 61.1, 54.5, 54.4 ppm).

### Example 4

### Modification of the Hyaluronic Acid with DTPA Bis Anhydride

The acid form of the hyaluronic acid HA-COOH (350 kDa, 50 mg) was dissolved in an anhydrous sulpholan (5 ml) at 60° C. DTPA bis anhydride (25 mg) was added to the polysaccharide solution at 60° C. and the mixture was stirred for 24 hours in absence of air humidity. After cooling of the mixture by ice water, distilled water and a solution of 150 mg of Na₂CO₃ in 30 mL of water were added, the mixture was stirred for 30 minutes and then was diluted by distilled water to 100 mL and dialysed against distilled water 7 times with 1 L. The final solution was lyophilized to yield 61 mg of the product.

M_{w}=2600 kDa, Polydispersity index=2.951 (measured by SEC-MALL method),

IR 1739 cm⁻¹, substitution degree 30% (calculated from NMR with respect to a polysaccharide dimer), ¹H NMR (calculated after the addition of 0.02 mL of 20% aq NaOD) DTPA (δ 2.55 4H, 2.6 4H, 3.10 2H, 3.5 6H), ¹³C NMR DTPA (δ 183.0, 182.8, 61.5, 61.1, 54.5, 54.4 ppm).

### Example 5

### Modification of the Hyaluronic Acid with DTPA Bis Anhydride

The acid form of the hyaluronic acid HA-COOH (350 kDa, 50 mg) was dissolved in an anhydrous DMSO (5 ml) at 60° C. DTPA bis anhydride (10 mg) was added to the polysaccharide solution at 60° C. and the mixture was stirred for 24 hours in absence of air humidity. After cooling of the mixture by ice water, distilled water and a solution of 150 mg of Na₂CO₃ in 30 mL of water were added, the mixture was stirred for 30 minutes and then was diluted by distilled water to 100 mL and dialysed against distilled water 7 times with 1 L. The final solution was lyophilized to yield 53 mg of the product.

M_{w}=2600 kDa, Polydispersity index=2.951 (measured by SEC-MALL method),

IR 1739 cm⁻¹, substitution degree 6% (calculated from NMR with respect to a polysaccharide dimer), ¹H NMR (calculated after the addition of 0.02 mL of 20% aq NaOD) DTPA (δ 2.55 4H, 2.6 4H, 3.10 2H, 3.5 6H), ¹³C NMR DTPA (δ 183.0, 182.8, 61.5, 61.1, 54.5, 54.4 ppm).

### Example 6

### Modification of the Hyaluronic Acid with DTPA Bis Anhydride

The acid form of the hyaluronic acid HA-COOH (2000 kDa, 50 mg) was dissolved in an anhydrous DMSO (10 ml) at 60° C. DTPA bis anhydride (95 mg) was added to the polysaccharide solution at 60° C. and the mixture was stirred for 24 hours in absence of air humidity. After cooling of the mixture by ice water, distilled water and a solution of 150 mg of Na₂CO₃ in 30 mL of water were added, the mixture was stirred for 30 minutes and then was diluted by distilled water to 100 mL and dialysed against distilled water 7 times with 1 L. The final solution was lyophilized to yield 68 mg of the product.

M_{w}=2600 kDa, Polydispersity index=2.951 (measured by SEC-MALL method),

IR 1739 cm⁻¹, substitution degree 76% (calculated from NMR with respect to a polysaccharide dimer), ¹H NMR (calculated after the addition of 0.02 mL of 20% aq NaOD) DTPA (δ 2.55 4H, 2.6 4H, 3.10 2H, 3.5 6H), ¹³C NMR DTPA (δ 183.0, 182.8, 61.5, 61.1, 54.5, 54.4 ppm).

### Example 7

### Preparation of HA-DTPA-Gd Complexes

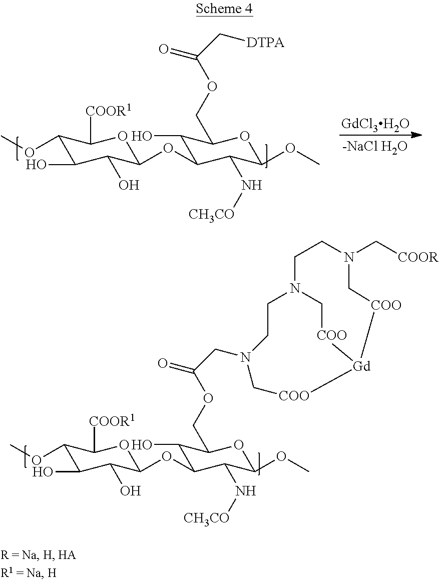

1% solution of GdCl₃.6H₂O (40 mg GdCl₃.6H₂O, 0.04 eq in water) was added to the solution of HA-DTPA (modified hyaluronic acid of Example 5) (substitution degree 6% mol, calculated with respect to a dimer of hyaluronic acid, 1 g) in water (100 mL) and the mixture was stirred for 1 hour at the room temperature. Then the final solution was dialysed against 1 L of distilled water, wherein no gadolinium was detected in the lyophilized solution after the evaporation of the solvent, using the chelating dye xylenol orange in acetate buffer. This fact, as well as the fact that the Gd concentration of 10⁻³ mg/ml is detectable in this way, implies that more than 95% of the added gadolinium was bound in HA-DTPA.

### Example 8

### Preparation of HA-DTPA-Fe Complexes

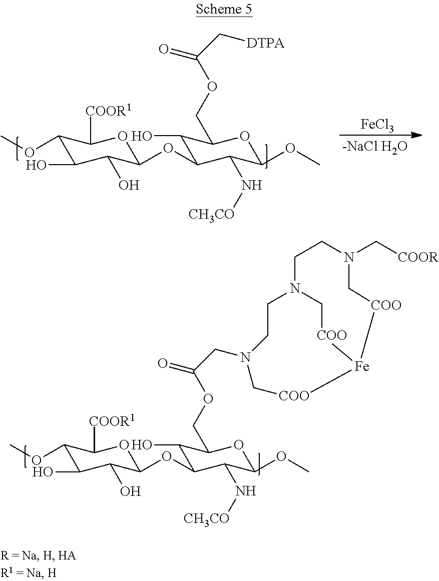

1% solution of FeCl₃ (20 mg FeCl₃, 0.04 eq in water) was added to the solution of HA-DTPA (modified hyaluronic acid of Example 5) (substitution degree 6% mol, calculated with respect to a dimer of hyaluronic acid, 1 g) in water (100 mL) and the mixture was stirred for 1 hour at the room temperature. Then the final solution was dialysed against 1 L of distilled water, wherein no iron was detected in the lyophilized solution after the evaporation of the solvent, using the chelating dye xylenol orange in acetate buffer. This fact, as well as the fact that the Fe concentration of 10⁻⁴ mg/ml is detectable in this way, implies that more than 97% of the added iron was bound in HA-DTPA.

### Example 9

### Preparation of HA-DTPA-In Complexes

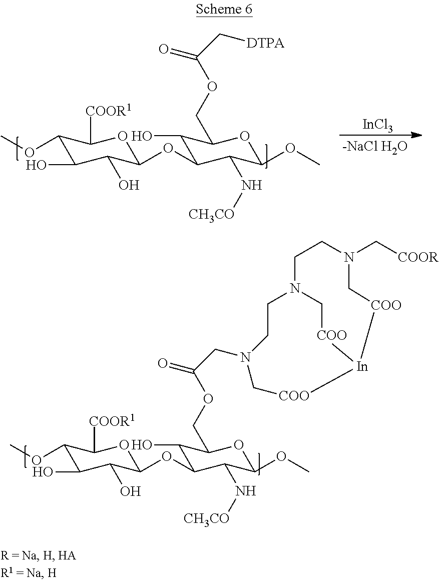

1% solution of InCl₃ (17 mg InCl₃, 0.04 eq in water) was added to the solution of HA-DTPA (modified hyaluronic acid of Example 5) (substitution degree 6% mol, calculated with respect to a dimer of hyaluronic acid, 1 g) in water (100 mL) and the mixture was stirred for 1 hour at the room temperature. Then the final solution was dialysed against 1 L of distilled water, wherein no indium was detected in the lyophilized solution after the evaporation of the solvent, using the chelating dye xylenol orange in acetate buffer. This fact, as well as the fact that the In concentration of 10⁻⁴ mg/ml is detectable in this way, implies that more than 97% of the added indium was bound in HA-DTPA.

### Example 10

### Preparation of HA-DTPA-Eu Complexes

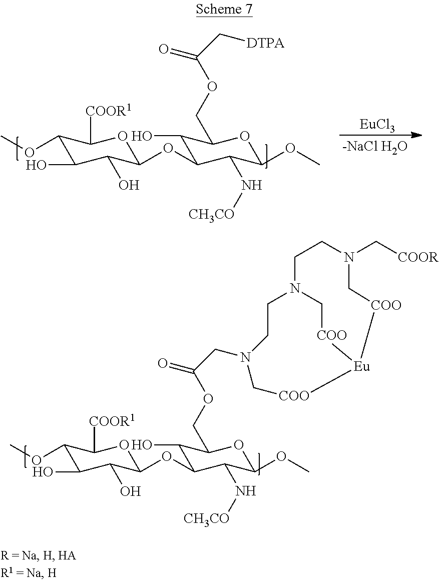

1% solution of EuCl₃ (40 mg EuCl₃, 0.04 eq in water) was added to the solution of HA-DTPA (modified hyaluronic acid of Example 5) (substitution degree 6% mol, calculated with respect to a dimer of hyaluronic acid, 1 g) in water (100 mL) and the mixture was stirred for 1 hour at the room temperature. Then the final solution was dialysed against 1 L of distilled water, wherein no europium was detected in the lyophilized solution after the evaporation of the solvent, using the chelating dye xylenol orange in acetate buffer. This fact, as well as the fact that the Eu concentration of 10⁻³ mg/ml is detectable in this way, implies that more than 95% of the added europium was bound in HA-DTPA.

### Example 11

### Preparation of HA-DTPA-Tb Complexes

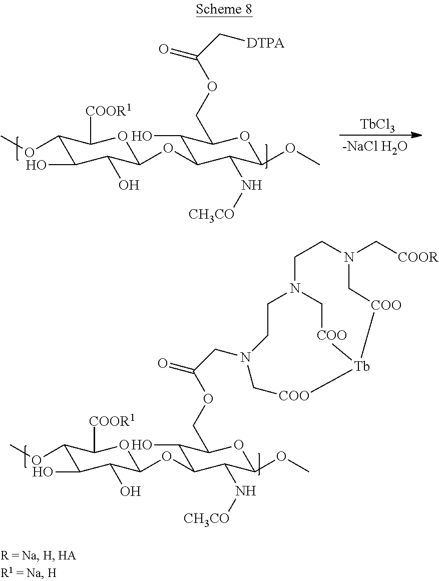

1% solution of TbCl₃ (40 mg TbCl₃, 0.04 eq in water) was added to the solution of HA-DTPA (modified hyaluronic acid of Example 5) (substitution degree 6% mol, calculated with respect to a dimer of hyaluronic acid, 1 g) in water (100 mL) and the mixture was stirred for 1 hour at the room temperature. Then the final solution was dialysed against 1 L of distilled water, wherein no therbium was detected in the lyophilized solution after the evaporation of the solvent, using the chelating dye xylenol orange in acetate buffer. This fact, as well as the fact that the Tb concentration of 10⁻³ mg/ml is detectable in this way, implies that more than 95% of the added therbium was bound in HA-DTPA.

### Example 12

### Preparation of HA-DTPA-Tb Complexes

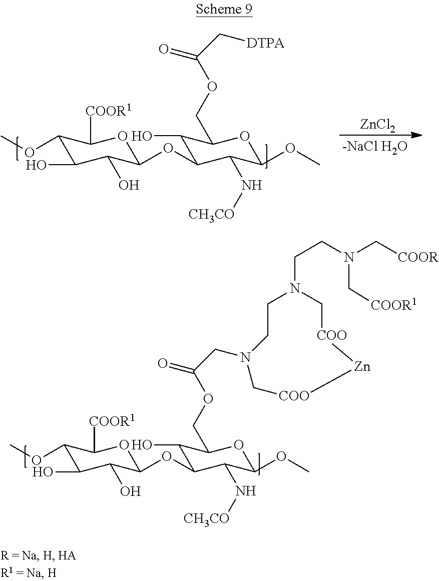

A solution of ZnCl₂ (0.04 eq) in water was added to the solution of HA-DTPA (modified hyaluronic acid of Example 5) (substitution degree 6% mol, calculated with respect to a dimer of hyaluronic acid, 1 g) in water (100 mL) and the mixture was stirred for 1 hour at the room temperature. Then the final solution was dialysed against 1 L of distilled water, wherein no zinc was detected in the lyophilized solution after the evaporation of the solvent, using the chelating dye xylenol orange in acetate buffer. This fact, as well as the fact that the Zn concentration of 10⁻⁴ mg/ml is detectable in this way, implies that more than 97% of the added zinc was bound in HA-DTPA.

### Example 13

### Preparation of HA-DTPA-Ca Complexes

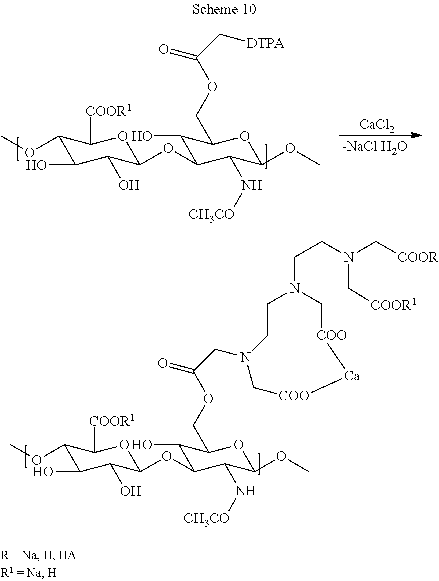

A solution of CaCl₂ (0.3 eq) in water (2 ml) was added to the solution of HA-DTPA (0.1 g substitution degree 30% mol, calculated with respect to a dimer of hyaluronic acid; derivative of Example 4) in water (10 mL) and the mixture was stirred for 1 hour at the room temperature. Then the reaction mixture was diluted to 300 mL and dialysed 7 times against 1 L of distilled water. The final solution was lyophilized to yield 110 mg of the product.

IR 1739 cm⁻¹, ¹H NMR (measured after the addition of 0.02 ml 20% aq NaOD) DTPA (δ 2.4 4H, 2.7 4H, 3.15 2H, 3.30 6H) ¹³C NMR DTPA (δ 64.4, 62.6, 58.5, 57.9 ppm).

ICP 3.1% Ca.

### Example 14

### Preparation of HA-DTPA-Mg Complexes

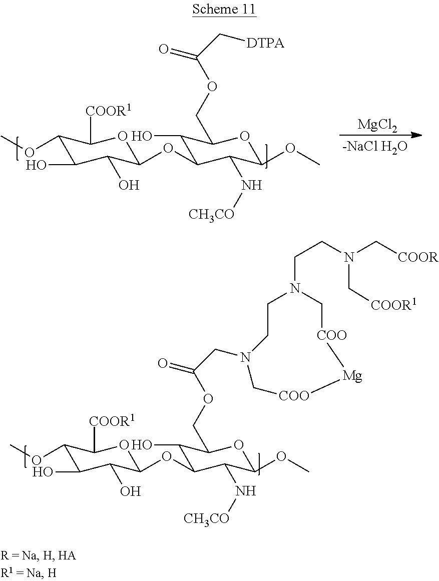

A solution of MgCl₂ (0.3 eq) in water (2 ml) was added to the solution of HA-DTPA (0.1 g; substitution degree 30% mol, calculated with respect to a dimer of hyaluronic acid; derivative of Example 4) in water (10 mL) and the mixture was stirred for 1 hour at the room temperature. Then the reaction mixture was diluted to 300 mL and dialysed 7 times against 1 L of distilled water. The final solution was lyophilized to yield 110 mg of the product.

IR 1739 cm⁻¹, ¹H NMR (measured after the addition of 0.02 ml 20% aq NaOD) DTPA (δ 2.4 4H, 2.7 4H, 3.15 2H, 3.30 6H) ¹³C NMR DTPA (δ 64.4, 62.6, 58.5, 57.9 ppm).

ICP 2.3% Mg.

### Example 15

### Alkylation of HA-DTPA-HA with Alkylhalogenides

The crosslinked form of hyaluronic acid HA-DTPA (100 mg, derivative of Example 1) was dissolved in water to form a 1% solution and DMSO was gradually added until the formation of a fine turbidity at the room temperature. A saturated aqueous solution of NaHCO₃ (2 eq) and hexylbromide (2 eq) were added to the mixture and the solution was heated to 60° C. for 48 hours. After cooling of the solution with ice water, a saturated aqueous solution of Na₂CO₃ (5 eq) was added, the mixture was stirred for 30 minutes and then diluted with distilled water to 150 mL, and dialysed against 5 L of distilled water (repeated 7 times). The final solution was lyophilized to yield 90 mg of the product.

IR 1738 cm⁻¹, ¹H NMR hexyl (δ 0.85 3H, 1.3 4H, 1.35 2H, 1.70 2H, 4.25 2H)

### Example 16

### Alkylation of HA-DTPA-HA with Alkyltosylates

The crosslinked form of hyaluronic acid HA-DTPA (100 mg, derivative of Example 1) was dissolved in DMSO to form a 0.5% solution. A saturated aqueous solution of NaHCO₃ (2 eq) and hexyltosylate (2 eq) were added to the mixture and the solution was heated to 60° C. for 48 hours. After cooling of the solution with ice water, a saturated aqueous solution of Na₂CO₃ (5 eq) was added, the mixture was stirred for 30 minutes and then diluted with distilled water to 150 mL, and dialysed against 5 L of distilled water (repeated 7 times). The final solution was lyophilized to yield 90 mg of the product.

IR 1737 cm⁻¹, ¹H NMR hexyl (δ 0.86 3H, 1.3 4H, 1.35 2H, 1.70 2H, 4.27 2H)

1. A method of preparation of hyaluronic acid derivatives characterised by that the hyaluronic acid reacts with the protonized diethylene triamine pentaacetic acid bis anhydride in a non-basic polar aprotic solvent in absence of an external base.

2. The method according to claim 1, characterised by that the hyaluronic acid is in the form of a free acid or a salt.

3. The method according to claim 1, characterised by that the hyaluronic acid has the molecular weight within the range from 1.10⁴ to 5.10⁶ g·mol⁻¹ and the polydispersity index within the range from 1.02 to 5.0.

4. The method according to claim 1, characterised by that the non-basic polar aprotic solvent is selected from the group comprising DMSO, sulpholan, or dialkysulphones.

5. The method according to claim 1, characterised by that the reaction of the hyaluronic acid with the protonized diethylene triamine pentaacetic acid bis anhydride takes place at to 70° C. for 1 to 150 hours in a non-basic polar aprotic solvent.

6. A use of the derivative obtained by the method according to claim 1 for the preparation of a complex of the derivative of the hyaluronic acid with diethylene triamine pentaacetic acid linked thereto, with metal atoms, wherein the derivative reacts with a metal halogenide or metal acetate in water and/or polar aprotic solvent.

7. The use according to claim 6, wherein the metal atoms are alkaline earth metals Ca, Mg, or transition metals Fe, Gd, In, Zn, Eu, Tb, and the solvent is selected from the group comprising DMSO, sulpholan or dialkylsulphones.

8. A use of the derivative obtained by the method according to claim 1 for the hydrophobization of the derivative of the hyaluronic acid with diethylene triamine pentaacetic acid linked thereto, by means of alkylating agents, wherein the derivative reacts with mono, bis or tris-functional alkylating agents in water and/or polar aprotic solvent and a base at the temperature of 15° C. to 70° C. for 1 to 150 hours.

9. The use according to claim 8, wherein the alkylating agent has the general formula R—X comprising one to three groups X wherein R is a C₁-C₃₀ alkyl linear or branched chain, optionally containing aromatic or heteroaromatic groups, and wherein X is a halogen or the group —O—SO₂—R.

10. The use according to claim 8, wherein the base is selected from the group comprising inorganic compounds of the general formula MHCO₃, M₂CO₃, MF, wherein M is an alkali metal, or nitrogen organic compounds of the general formula R₃N wherein R is a C₁-C₃₀ alkyl linear or branched chain, optionally containing aromatic or heteroaromatic groups, and the solvent is selected from the group comprising DMSO, sulpholan or dialkylsulphones.
